(19) United States
(12) Patent Application Publication
(10) Pub. No.: US 2011/0202841 A1
(43) Pub. Date: Aug. 18, 2011

(54) COMPUTER-BASED PROJECT MANAGEMENT

(76) Inventors: Benjamin I. Dempster, San Francisco, CA (US); Jhilmil Jain, Mountain View, CA (US)

(21) Appl. No.: 12/704,779

(22) Filed: Feb. 12, 2010

(51) Int. Cl. G06Q 10/00; G06Q 30/00; G06F 3/048; G06F 3/01

(52) U.S. Cl. 715/716; 705/80; 715/769

(57) ABSTRACT

Computer-based methods for managing a project are disclosed. The computer-based method may include displaying a plurality of images in a first portion of a computer screen, each image of the plurality of images being representative of at least one of a service and a good; detecting movement of at least one image of the plurality of images from the first portion to a second portion of the computer screen spaced from the first portion; soliciting one or more vendors for proposals to provide at least one of a service and a good represented by the at least one image moved to the second portion; displaying the proposals received from the solicited vendors on the computer screen; and detecting approval of one or more of the displayed proposals.

### BACKGROUND

Vendor resource management typically is a critical business function in at least two types of workgroups. First, professional service companies that deliver highly customized and creative solutions to clients, such as event planning, construction, video/film production, real estate development, research, and travel planning. Second, corporate research and development where highly complex multi-disciplinary engineering and new product development processes are prevalent, such as in the industries of automotive goods, fashion, consumer electronics, consumer packaged goods, drugs, toys and games, software, recreational goods, and furniture. Both types of workgroups typically manage multiple complex projects with a “job shop” operational model in which dedicated teams stay with projects through their entire lifecycle.

Projects and programs managed by the above workgroups may involve the sourcing and managing of a diverse set of inter-dependent vendors across several different service and product categories. Additionally, the projects and programs may involve scopes and outcomes that are highly variable. Thus, teams must react quickly to shifting requirements and resource levels over the life of the project. Those requirements and resource levels require project managers to quickly communicate changing requirements to vendors and/or to efficiently find new vendors. Moreover, the projects and programs may require intensive client (or sponsor) involvement to achieve highly customized solutions. Those clients may have to make fast vendor product and service decisions with minimal expertise and time.

### BRIEF DESCRIPTION OF THE DRAWINGS

FIG. 1 is an example of a computer system configured to manage a project in accordance with an embodiment of the invention.

FIG. 2 is a flowchart of an example of a computer-based method for managing a project implemented by the computer system of FIG. 1 in accordance with an embodiment of the invention.

FIG. 3 is an example of a display generated by the computer system of FIG. 1 in accordance with an embodiment of the invention.

FIG. 4 is another example of a display generated by the computer system of FIG. 1 in accordance with an embodiment of the invention.

FIG. 5A is a first half of another example of a display generated by the computer system of FIG. 1 in accordance with an embodiment of the invention.

FIG. 5B is a second half of the display shown in FIG. 5A generated by the computer system of FIG. 1 in accordance with an embodiment of the invention.

FIG. 6 is another example of a display generated by the computer system of FIG. 1 in accordance with an embodiment of the invention.

### DETAILED DESCRIPTION

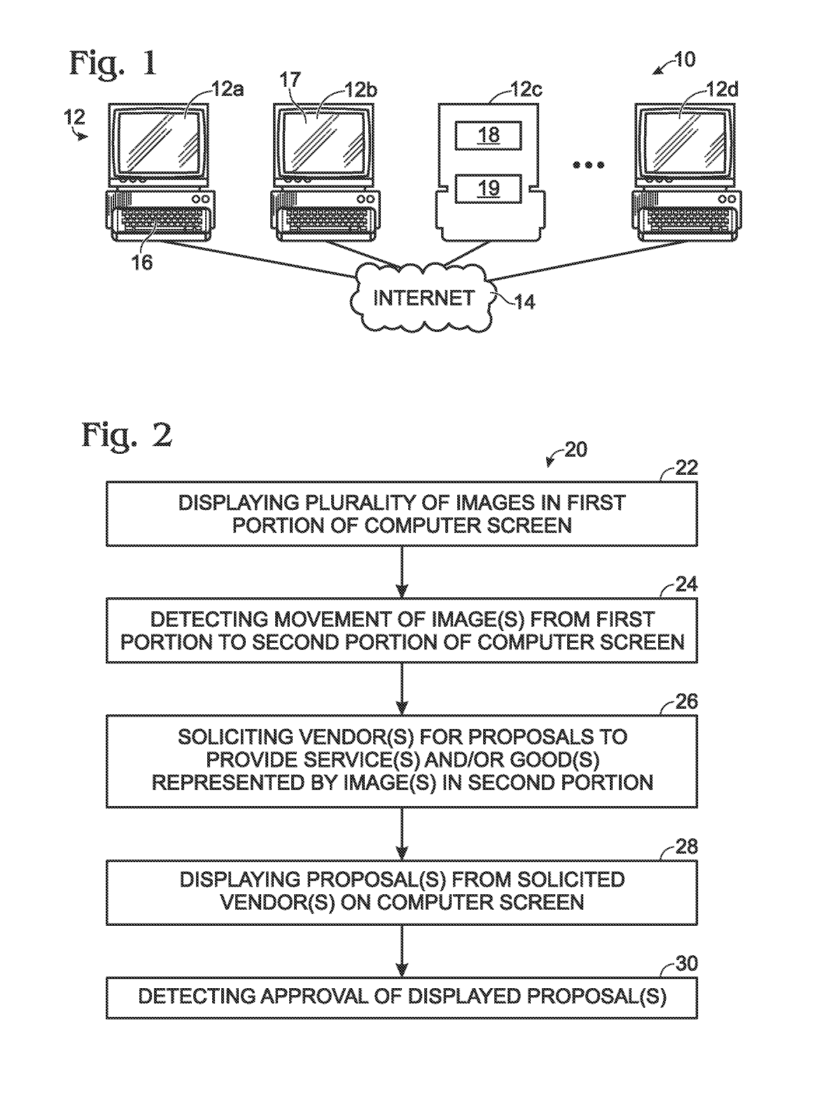

FIG. 1 shows a computer system 10 configured to manage a project. The computer system may include a plurality of computers 12, such as computers 12a, 12b, 12c, and 12d, which may be connected to Internet 14. Computers 12 may have one or more user interfaces or user-input devices 16, such as a keyboard, a mouse, and/or a scanner. The computers also may include one or more output devices 17, such as a monitor, a printer, and/or a speaker. Computers 12 may take various forms, such as laptops, hand-held mobile devices (such as an internet-equipped personal data assistant mobile phone), tablet computers, desktop computers, and/or other Internet-enabled devices. Additionally, the computers may include any suitable structure, such as a controller 18 and memory 19.

Each person involved in a project may have a computer 12 that may form a part of computer system 10. For example, a client may have computer 12a and may use that computer to, for example, specify one or more requirements of the project. Additionally, a project manager may have computer 12b and may use that computer to, for example, request proposals from vendors, order goods and services that meet the client's requirements, check status of those orders, and/or keep track of the vendors. Moreover, vendors may have computers 12c and 12d and may use those computers to submit proposals and/or keep track of orders.

Although four computers 12 are shown, any suitable number of computers may be connected together via the Internet (and/or any other suitable method) to form computer system 10. Additionally, although computer system 10 is shown to include computers 12, the computer system may include other suitable components, such as servers, databases, etc.

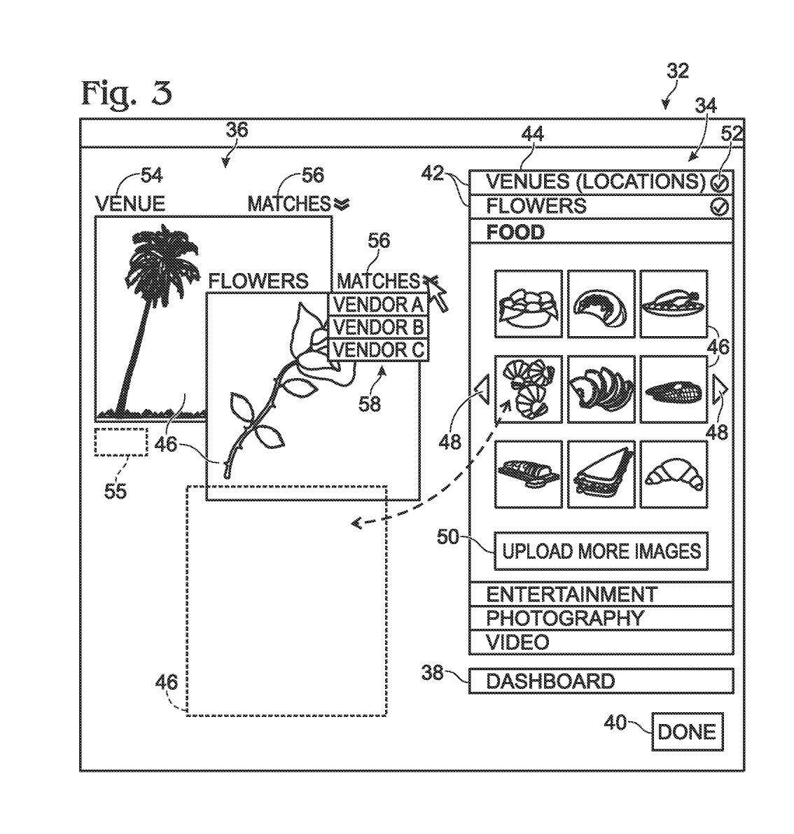

FIG. 2 shows a flow diagram showing an example of a computer-based method 20 for managing a project. While FIG. 2 shows illustrative steps of a method according to one example, other examples may omit, add to, and/or modify any of the steps shown in that figure. In step 22, a plurality of images may be displayed in a first portion of a computer screen. Each image of the plurality of images may be representative of a service and/or a good. For example, an image of a welder's torch may be representative of a welding service, an image of a computer-aided design (CAD) drawing may be representative of a design service, or an image of cereal and fruit may be representative of a continental breakfast.

The images may be grouped together by category or services or goods and those grouped images may be displayed in the first portion of the computer screen. For example, if the project involves creating and selling a new product, the categories may include, design and engineering services, raw materials, manufacturing services, legal services, marketing and advertising services, and distribution services. The raw materials category may include, for example, images representative of wood, steel, plastic, etc. Each category may include a drop down menu that a user may select to reveal the grouped images in the selected category.

New images may be received from a computer and added to the plurality of images displayed in the first portion of the computer screen. For example, a user may cut and paste an image from the Internet or may scan an image using a scanner and upload that image. The new images may be assigned a service or a good that the images represent. For example, the new images may be assigned to the category of goods or services that the images were uploaded into by a user.

In the new product example above, if a user is viewing images under the marketing and advertising service category and uploads a new image of a convention booth, then that image would be assigned the category of marketing and advertising services. Alternatively, or additionally, image recognition software may be used to assign the appropriate service or good (or category of service or good) represented by the image. Additionally, or alternatively, a user may be prompted to manually enter the service or good the image represents.

In step 24, movement of one or more images from the first portion to a second portion spaced from the first portion (or placement of those images in the second portion) may be detected. The images may be moved in any suitable way, such as via a mouse or other user-input device 16 of computer 12. The first and second portions may be in any suitable locations of the computer screen. The moved images may include one or more new images uploaded by the user.

Steps 22 and/or 24 may be referred to as being part of a “scrapbooking process” that may allow a user to specify requirements, such as by selecting goods and services of interest via dragging-and-dropping images representative of those goods and services. The first portion may be referred to as a “scrapbooking browser toolbar,” while the second portion may be referred to as a “scrapbook canvas.” The scrapbook canvas may be in any area of the screen that is not occupied by the scrapbooking browser toolbar. The toolbar and canvas may be configured to be moved around the screen by the user, such as via a user-input device. The scrapbooking process may allow a user, such as a client or project manager, to more clearly understand the different goods and services available and to envision the end result of the project.

In step 26, one or more vendors that provide the services or goods represented by the image(s) moved to the second portion may be solicited. For example, request-for-proposals (RFPs) may be sent, such as via e-mail, to the vendors inviting or requesting the vendors to submit proposals via computer system 10. Any suitable vendors may be solicited. For example, all vendors that have registered with computer system 10 may be solicited.

Alternatively, only vendors identified to provide the particular services or goods (or category of service or goods) represented by the images moved to the second portion of the computer screen may be solicited. A list may be generated of those vendors identified to provide the particular services or goods represented by the images moved to the second portion. That list may be used to solicit the appropriate vendors.

Alternatively, the vendor(s) that will be solicited may be received from a user. For example, a list of vendors that provide the service or good represented by each image moved to the second portion may be generated. That generated list may be displayed. Additionally, selection of which vendors will be solicited from that generated list may be detected. For example, one or more of the images moved to the second portion may be provided with an icon. Selection of the icon, such as via a user-input device of a computer may be detected and a list of vendors may be displayed. Alternatively, the list may automatically be displayed when the image is moved to the second portion. Selection of one or more vendors from the generated list may be detected.

In step 28, proposals received from the solicited vendors may be displayed on a computer screen. Thus, a user's selection of images that represent desired services and goods from the above steps may be transformed to proposals from vendors that provide those desired services and goods. In step 30, approval of one or more of those proposals may be detected. Steps 26, 28, and/or 30 may be referred to as being part of a “vendor marketplace process” that may identify vendors of interest and track user interactions with one or more of those vendors of interest.

Computer-based method 20 may include one or more additional steps. For example, one or more audio and/or video clips regarding the service(s) and/or good(s) represented by the image(s) moved to the second portion may be played (or displayed). The audio and/or video clips may include any suitable content. For example, the audio clip(s) may include a narrative and/or sound effect of the service(s) and/or good(s) represented by the images. The video clip(s) may, for example, include a video showing the service and/or good in action. For example, for an image of a welder's torch that represents a welding service, a video clip showing the welder's torch in use may be displayed and/or an audio clip with the sound of welding may be played.

Additionally, or alternatively, confirmation of delivery of the service(s) and/or good(s) described in the approved proposal(s) may be received from a user. Alternatively, or additionally, feedback regarding the vendor(s) of the approved proposal(s) may be received from a user.

Additionally, or alternatively, data associated with the service(s) and/or good(s) represented by the image(s) moved to the second portion may be displayed. The data may be displayed in any suitable form(s). For example, the data may be displayed in graph form, such as bar graphs, line graphs, pie charts, etc. Additionally, any suitable data may be provided and that data may be collected from any suitable sources, such as the scrapbook canvas of various computer screens, project templates, vendor product and pricing databases, etc. For example, the data may include price or cost data, such as the cost over a particular time period of the service or good represented by the moved image or the total cost over a particular time period of a project. That price data may include data from proposals received from solicited vendors or from approved proposals.

Alternatively, or additionally, the data may include distribution data, such as a percentage of a service or good represented by a moved image was selected over other services or goods in the same category. For example, the percentage that wood was selected as a raw material for a toy over other raw materials, such as steel, plastic, etc. Other type(s) of data may alternatively, or additionally be displayed. The data associated with the service(s) and/or good(s) may be referred to as “analytics” and the process of obtaining that data may be referred to as a “data mining process.”

One or more of the steps discussed above may overlap with one or more other steps or may be completed before another step is taken. For example, soliciting of the vendors may be completed prior to displaying the proposals. Alternatively, receipt of the proposals from the vendors may be completed prior to displaying the proposals. Additionally, or alternatively, displaying of the proposals may be completed before a user may approve one or more of the proposals (or before that approval may be detected). When a previous step must be completed before the next step, the method may be referred to as a “structured workflow.”

Any suitable structure may be used or configured to perform one or more steps of the above method, such as computer system 10 described above. For example, controller 18 of one or more of computers 12 may be configured to perform one or more of those steps. Those systems also may include a computer-readable medium having computer-executable instructions for managing a project, the instructions causing a computer to perform one or more steps of method 20 discussed above.

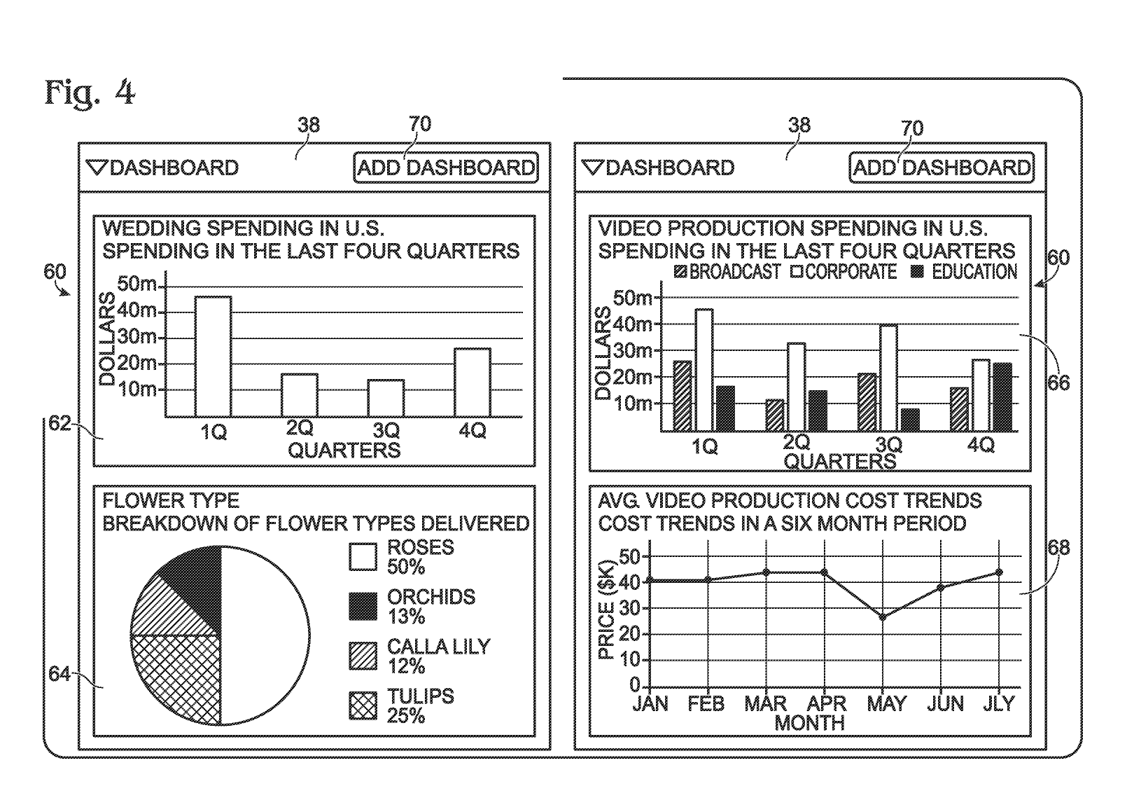

FIGS. 3-6 show examples of displays generated by computer system 10 for planning an event, such as a wedding. The displays may be shown on one or more computer screens, such as a computer screen of computer 12 used by a client (e.g., bride) and/or a project manager (e.g., wedding planner).

Computer system 10 may require a user to go through a step-by-step process, such as a process with the following steps: requirements, RFPs, proposals, contracts, payments, and feedback. A user may be required to specify requirements, such as requirements of the wedding. The RFPs may be sent to the appropriate vendors, and proposals may be received from those vendors. Entering into contracts with one or more of the vendors may be facilitated and payments may be made to those vendors. Feedback may be received from a user regarding the vendors.

FIG. 3 shows an example display 32 with a scrapbooking browser toolbar 34, a scrapbook canvas 36, a dashboard toolbar 38, and a completion button 40. The scrapbooking browser toolbar may include a plurality of expandable menu bars 42 with each menu bar having a label 44 that designates a particular category of a service or good. For example, the categories of “venues (locations),” “flowers,” “food,” “entertainment,” “photography,” and “video” are shown in FIG. 3 for a wedding project.

Each menu bar 42 may include a plurality of images 46 that represents services or goods that belong to a particular category of service or good identified by corresponding label 44 of the menu bar. For example, the “food” menu bar includes a plurality of images that represent different types of food that may be provided at the wedding. One or more of the images may be moved from the menu bar to the scrapbook canvas to indicate that the user is interested in the goods and/or services represented by the moved images. For example, dashed lines in FIG. 3 show movement of an image of shrimps from the food menu bar to the scrapbook canvas. The image of shrimps may indicate that the user is interested in a seafood dinner and/or a shrimp appetizer for the wedding.

Although particular categories are shown, the scrapbooking browser toolbar may additionally, or alternatively, include other categories such as “drinks” and “gifts,” “wardrobe,” etc. Additionally, a user may be provided the ability to add new categories and to upload images to those new categories. For example, if the bride wants souvenir gifts for each guest and there is no category for gifts, then a user may add a new category with a “gifts” label and upload images into that category.

Additionally, each menu bar 42 may include one or more scroll buttons 48, an upload button 50, and a status indicator 52. The scroll buttons may be configured to allow a user to view other images not displayed. The upload button may be configured to allow the user to upload new images, such as images scanned from a scanner or copied from a document or the Internet. The new images may be added to the other images in the menu bar.

Status indicator 52 may include any suitable indicator(s) configured to indicate whether at least one image from the particular menu bar has been moved to the scrapbook canvas. For example, the menu bar may include a check mark if at least one image has been moved to the scrapbook canvas, and may be blank (or have an “X” or other mark) when an image has not been moved to the scrapbook canvas. In the example of FIG. 3, scrapbook canvas 36 includes an image from the “venue” menu bar and the “flowers” menu bar so the menu bars for the venue and flowers categories have a check mark to indicate that the user has already chosen at least one image from those categories. Although status indicator 52 is shown to be either a check mark or the absence of any mark, the status indicator may be any suitable indicator(s).

Scrapbook canvas 36 may be an area on the computer screen that includes images 46 moved by a user from the scrapbooking browser toolbar to indicate that the user is interested in the services and/or goods represented by those moved images. Each image 46 moved to the scrapbook canvas may be displayed with a category identifier 54 that indicates which menu bar or category the image came from. In the example of FIG. 3, an image of a palm tree is displayed with a “venue” category identifier, while an image of a rose is displayed with a “flowers” category identifier.

Additionally, or alternatively, each image 46 moved to scrapbook canvas 36 may be displayed with additional information icon 55. The icon may include text that describes the service and/or good represented by the image. For example, the image of a palm tree in FIG. 3 may include “Hawaii.” A user may select the additional information icon, such as via a mouse or other user-input device, and one or more audio and/or video clips regarding the service and/or good represented by the image may be played in response to that selection.

In the above example, a user may click on “Hawaii” and audio and/or video clips regarding Hawaii may be played in response to that click. The audio clip may, for example, have ocean sounds and/or narrative regarding Hawaii. The video clip may, for example, show potential scenic locations for the wedding in Hawaii. Alternatively, or additionally, a user may select the image itself, such as via a mouse or other user-input device, and the audio and/or video clip(s) may be played in response to that selection. Although additional information icon 55 is shown to be displayed only when the image is moved to the scrapbook canvas, the images in the scrapbooking browser toolbar may additionally, or alternatively, include the additional information icon. The scrapbook canvas may be multimodal, in that it may contain any or all of image files, text, audio files, and video files.

Additionally, or alternatively, each image 46 moved to scrapbook canvas 36 may be displayed with a vendor list icon 56. A user may select the vendor list icon, such as via a mouse or other user-input device, and a vendor list 58 of vendors that provide the service or good represented by the image may be displayed in response to that selection. In the example of FIG. 3, a user selected vendor list icon 56 for the rose image, and a list of vendors that provide roses was displayed in response to that selection. A user may select one or more of the vendors on the list to obtain more information about the vendors and/or designate the vendors to send RFPs. Although vendor list 58 is shown to include only three vendors, the vendor list may include any suitable number of vendors.

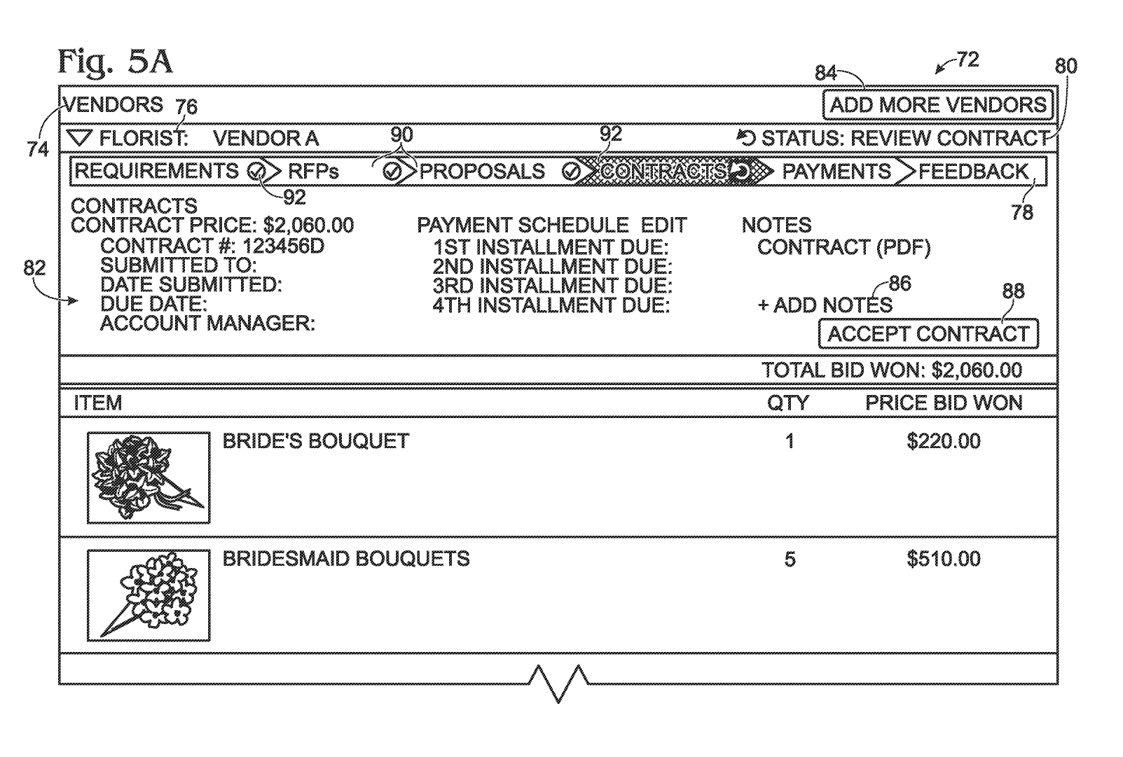

Dashboard toolbar 38 is configured to provide data 60 associated with the images moved to the scrapbook canvas, the type of event, and/or other relevant data. For example, a user may select, such as via a mouse or other user-input device, the dashboard toolbar to expand the toolbar and/or reveal the data. FIG. 4 shows examples of dashboard toolbar 38. Any suitable type(s) of data 60 may be displayed in any suitable form(s). For example, data 60 may include project spending data 62, services or goods distribution data 64, services or goods spending data 66, and services or goods cost trends data 68. Data 60 may be displayed in graphical form, as shown in FIG. 4, and/or other suitable forms, such as tabular form, list form, etc.

Dashboard toolbar 38 may include an addition button 70 which a user may select so that a list of available data is displayed. The user may be provided the ability to add or remove data 60 in the dashboard toolbar using a mouse and/or other user-input device. The data available via the dashboard toolbar allows a user to make informed decisions, such as what types of goods and/or services to select. For example, if a wedding planner wants to select flowers, the planner may use distribution data 64 to select the most popular flower (i.e., roses), a less popular flower (e.g., calla lily), or a more unique flower (i.e., any flower not shown in the distribution data).

Although display 32 is shown to include a single dashboard toolbar 38 in FIG. 3, the display may alternatively, or additionally, include image-specific dashboard toolbars for each image. For example, a “venue” dashboard toolbar may be adjacent the venue image and a user may access data specific to the particular venue represented by the image.

Completion button 40 may be selected by the user when all the desired images have been moved to the scrapbook canvas. The computer system may prevent activation of the completion button until at least one image has been moved from each of the categories available. For example, the completion button may not be available until the status indicator for all categories has a check mark and/or at least one vendor for each image moved to the scrapbook canvas has been designated. Selection or activation of the completion button may signify completion of the scrapbooking process for managing a project and the start of the vendor marketplace process.

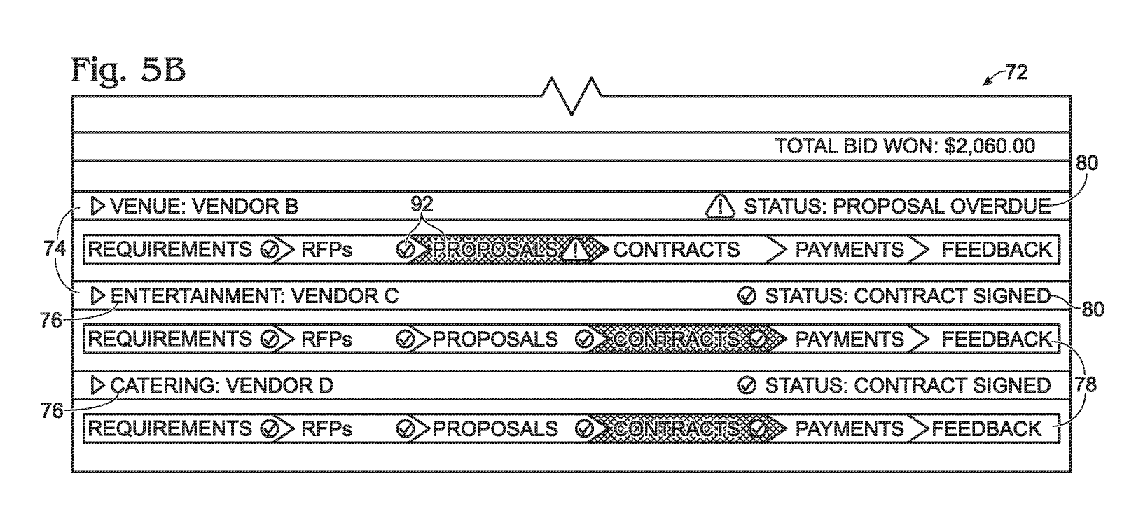

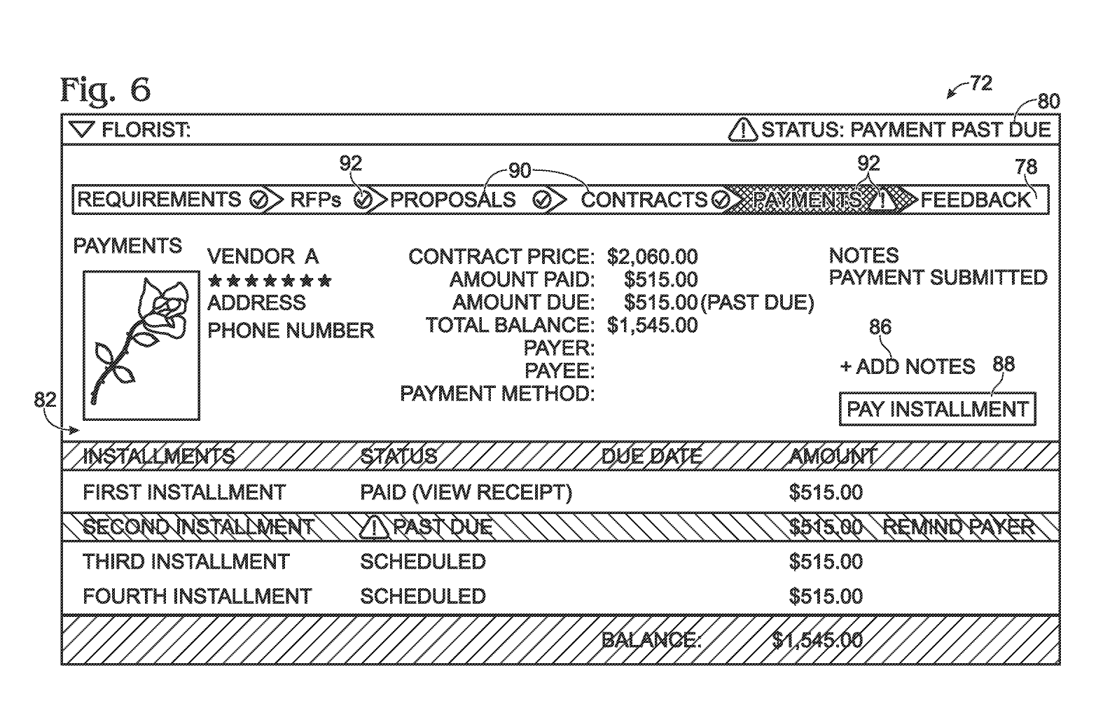

FIGS. 5-6 show other examples of a display 72 with a plurality of expandable menu bars 74. Each menu bar 74 may include a label 76, a workflow indicator 78, a status identifier 80, a details section 82, a vendor addition button 84, a notes addition button 86, and an action button 88. Labels 76 for menu bars 74 may reflect the category of services or goods, which may correspond to labels 44 of menu bars 42.

Workflow indicator 78 may indicate stages 90 of the vendor marketplace process and the current stage of that process. For example, the different stages may be “requirements,” “RFPs,” “proposals,” “contracts,” “payments,” and “feedback.” The stages may vary depending on the type of project involved. The workflow indicator may include indicia 92, which may indicate which stages have been completed (such as via check mark and/or other indicium), which stages have not been completed (such as via the absence of any indicium or other indicium), which is the stage in progress (such as via an arrow and/or other indicium), and/or which stage details are currently being displayed (such as via highlighted background indicium). Workflow indicator 78 also may allow a user to have details from stages other than the current stage displayed, such as by selecting the stage via a mouse or other user-input device.

In FIG. 5, the workflow indicator shows, via check mark indicia, that the requirements have been specified (such as via the scrapbooking process), the RFPs have been sent to the florist vendors, and the proposals from those vendors have been received. Additionally, workflow indicator 78 shows, via an arrow indicium, that the current stage is the contract stage. Moreover, the workflow indicator shows, via highlighted background indicium, that details of the contracts stage is currently being displayed. Although particular indicia are shown, workflow indicator 78 may additionally, or alternatively, include other suitable types of indicia.

In FIG. 6, workflow indicator 78 shows, via check mark indicia, that the requirements have been specified, the RFPs have been sent to the florist vendors, the proposals from those vendors have been received, and that a contract exists between one or more of the vendors. Additionally, the workflow indicator shows, via exclamation point indicium, that the current stage is the payments stage and an action is past due. Moreover, workflow indicator 78 shows, via highlighted background indicium that the details of the payments stage are currently being displayed.

Status identifier 80 may provide additional detail regarding the status of a particular stage. For example, in FIG. 5, the status identifier indicates to the user that a contract with florist vendor A needs to be reviewed. In FIG. 6, the status identifier indicates that a payment to florist vendor A is past due. Additionally, the status identifier may indicate that requirements are needed or have been submitted in the requirements stage; that vendors need to be selected, RFPs need to be sent, or RFPs have been sent in the RFPs stage; that proposals have not been received, are overdue, or have been received in the proposals stage, etc.

Details section 82 may provide details for each workflow stage. For example, in FIG. 5, the details section for contracts stage is shown with contracts information, payment schedule information, item information (including images selected, quantity, and price), and a downloadable contract file. In FIG. 6, details section 82 for payment stage shows vendor information, contract information, and payment deadlines and status information. One or more of the information in the details section may be editable. For example, the payment schedule in FIG. 5 may be editable to allow the user to indicate, for example, what particular day of the month payments will be made.

Vendor addition button 84 may allow a user to add one or more vendors during one or more workflow stages. For example, in FIG. 5, even though a user already has a contract that may be entered with vendor A, that user may add more vendors to the process. The computer system may detect activation of the vendor addition button and may, for example, notify the added vendors accordingly. Those vendors may be added to the initial requirement stage or any other suitable stage. A user may be allowed to consider additional vendors even though the user did not initially select those vendors.

Notes addition button 86 may allow a user to add one or more notes to the details section. The notes may be in any suitable form(s), such as text, images, uploaded files, etc. The computer system may detect activation of that button and provide a user interface to accept additional notes. Action button 88 may allow a user to perform one or more actions relevant to a particular stage. For example, in the contract stage in FIG. 5, a user may accept a contract using the action button. The computer system may detect activation of the action button and may, for example, notify the particular vendor accordingly. Additionally, in the payment stage in FIG. 6, a user may pay a vendor using the action button. Although single vendor addition, notes addition, and action buttons are shown, the display may include two or more of those buttons.

Although FIGS. 3-6 show displays 72 that may be generated by computer system 10 for a wedding event, the computer system may be used for all suitable types of applications. For example, computer system 10 may be used by project-intensive service companies, such as companies that manage construction, video/film production, advertising/marketing, product design and engineering, other event planning, real estate development, research, travel planning, and/or other suitable projects. Computer system 10 also may be used in research and development or new product development groups for various companies, such as companies that manufacture automotive parts, apparel, consumer electronics, consumer packaged goods, drugs, toys and games, software, recreational goods, furniture and fixtures, and/or other suitable goods.

The computer system may be used by project managers, workgroups, and/or other suitable users. Computer system 10 may allow those users to efficiently gather, codify, and/or distribute client requirements for projects and programs. Additionally, the computer system may provide a centralized database for efficient discovery of relevant and appropriate vendors across different categories and geographies. Moreover, computer system 10 may provide automated matching of vendor offerings with project and program requirements to help with vendor selection.

Furthermore, the computer system may automate (1) sending RFPs to selected vendors, (2) reviewing received vendor proposals, (3) developing and confirming vendor contracts, and/or (4) coordinate vendor invoicing and payments. Computer system 10 may allow clients and/or project managers to make payments on time to ensure that projects stay on schedule and/or evaluate efficient resource allocation.

We claim:

1. A computer-based method for managing a project, comprising:
displaying a plurality of images in a first portion of a computer screen, each image of the plurality of images being representative of at least one of a service and a good;
detecting movement of at least one image of the plurality of images from the first portion to a second portion of the computer screen spaced from the first portion;
soliciting one or more vendors for proposals to provide at least one of a service and a good represented by the at least one image moved to the second portion;
displaying the proposals received from the solicited vendors on the computer screen; and
detecting approval of one or more of the displayed proposals.

2. The method of claim 1, further comprising receiving at least one new image from a computer, and adding the at least one new image to the plurality of images.

3. The method of claim 2, wherein detecting movement of at least one image includes detecting movement of the at least one new image from the first portion to the second portion of the computer screen, further comprising soliciting one or more vendors for proposals to provide at least one of a service and a good represented by the at least one new image moved to the second portion.

4. The method of claim 1, wherein soliciting one or more vendors for proposals for a particular service or good is completed prior to displaying the proposals from the solicited vendors of the particular service or good on the computer screen.

5. The method of claim 1, further comprising generating a list of vendors that provide at least one of a service and a good represented by the at least one image moved to the second portion.

6. The method of claim 5, wherein soliciting one or more vendors for proposals includes soliciting one or more vendors from the generated list of vendors.

7. The method of claim 5, further comprising providing an icon with each image moved from the first portion to the second portion, detecting when the icon of a first image in the second portion is selected via a user interface of a computer, and displaying the generated list of vendors that provide at least one of a service and a good represented by the first image moved to the second portion.

8. The method of claim 1, wherein displaying the proposals from the solicited vendors for a particular service or good is completed before detecting approval of one of the displayed proposals for the particular service or good.

9. The method of claim 1, wherein displaying a plurality of images in a first portion of a computer screen includes grouping together images that represent a same category of services or goods and displaying the grouped images in the first portion of the computer screen.

10. The method of claim 1, further comprising playing at least one of an audio clip and a video clip regarding at least one of a service and a good represented by the at least one image moved to the second portion.

11. The method of claim 1, further comprising displaying, in graph form, data associated with at least one of a service and a good represented by the at least one image moved to the second portion.

12. The method of claim 11, wherein the data includes price data over a particular time period of the service or good represented by the at least one image.

13. The method of claim 11, wherein the data includes a percentage that a service or good represented by the at least one image was selected over other services or goods in a same category.

14. The method of claim 1, further comprising receiving feedback regarding a vendor of the one or more approved proposals.

15. A computer-readable storage medium having computer-executable instructions for managing a project, the instructions causing a computer to perform steps, comprising:
displaying a plurality of images in a first portion of a computer screen, each image of the plurality of images being representative of at least one of a service and a good;
detecting placement, via a user interface of a computer, of at least one image of the plurality of images in a second portion of the computer screen spaced from the first portion;
receiving proposals from vendors that provide at least one of a service and a good represented by the at least one image placed in the second portion; and
displaying the proposals from solicited vendors on the computer screen.

16. The computer-readable storage medium of claim 15, further including computer-executable instructions for receiving at least one new image from a computer, and displaying the at least one new image with the plurality of images.

17. The computer-readable storage medium of claim 15, further including computer-executable instructions for generating a list of vendors that provide at least one of a service and a good represented by at least one image placed in the second portion, and displaying the generated list of vendors that provide at least one of a service and a good represented by the image placed in the second portion.

18. A computer system configured to manage a project, the computing system being configured to:
display a plurality of images in a first portion of a computer screen, each image of the plurality of images being representative of at least one of a service and a good;
detect movement, via a user interface of a computer, of at least one image of the plurality of images from the first portion to a second portion of the computer screen, the second portion being spaced from the first portion;
receive proposals from vendors that provide at least one of a service and a good represented by the at least one image moved to the second portion;
display the proposals from the solicited vendors on the computer screen; and
detect approval of one of the displayed proposals.

19. The computer system of claim 18, further configured to solicit one or more vendors for proposals to provide at least one of a service and a good represented by the at least one image moved to the second portion of the computer screen.

20. The computer system of claim 18, further configured to display, in graph form, data associated with the at least one image moved to the second portion.
